(19) United States
(12) Patent Application Publication
(10) Pub. No.: US 2011/0233344 A1
(43) Pub. Date: Sep. 29, 2011

(54) Satellite control system

(76) Inventors: Charles E. Hunter, Boone, NC (US); Jurgen Klaus Vollrath, Indian Trail, NC (US); John H. Hebrank, Durham, NC (US); Bernard L. Bailou, JR., Raleigh, NC (US); Judson Sidney Clements, Boone, NC (US); Thomas Johannes Lindner, Corvallis, OR (US); Ravi Prasad, Corvallis, OR (US); Philip E. Russell, Boone, NC (US); Elliott M. Pines, Los Angeles, CA (US); David W. Carey, Vienna, VA (US)

(21) Appl. No.: 12/804,174

(22) Filed: Jul. 15, 2010

Related U.S. Application Data
(63) Continuation-in-part of application No. 12/800,638, filed on May 19, 2010.
(60) Provisional application No. 61/341,121, filed on Mar. 26, 2010.
(60) Provisional application No. 61/342,649, filed on Apr. 16, 2010.

(51) Int. Cl. B64G 1/26; G05D 1/08

(52) U.S. Cl. 244/169; 701/13

(57) ABSTRACT

In a satellite control system, a liquid is ejected by thermal ejection from holes in a substrate structure to create a reactive force on the satellite allowing the position, such as the attitude, of the satellite to be adjusted.

This is a Continuation-In-Part application of U.S. application Ser. No. 12/800,638 to Charles E. Hunter filed May 19, 2010, which claims priority from provisional application 61/341,121 to Charles E. Hunter et. al filed Mar. 26, 2010 and, provisional application 61/342,649 to Charles E. Hunter et. al filed Apr. 16, 2010.

### FIELD OF THE INVENTION

The invention relates to satellite systems. In particular it relates to position control such as attitude control of a satellite.

### BACKGROUND OF THE INVENTION

For purposes of this invention the three dimensions of movement of a satellite will be referred to in this application as attitude, whether it includes pitch, yaw or role of the satellite. Traditionally attitude control for satellites has been achieved through the use of rockets generating a thrusting force thereby adjusting the attitude of the satellite by Newton's third law of motion: For every action there is an equal and opposite reaction. In other words by exerting the force of thruster rockets in one direction, the rocket is caused to accelerate in the opposite direction. The use of rockets, however, severely limits the accuracy with which the attitude can be adjusted. Typically, liquid fuel rockets are used for this purpose in which nozzles emit the rocket fuel and can be opened or shut off. While this allows the duration of the force to be roughly adjusted it does not allow for either fine control of the duration, or control of the amount of force generated by the rockets.

A monopropellant liquid fuel thruster relying on valve control typically relies on a monopropellant such as hydrazine or hydrogen peroxide that has to be contained and then selectively released into a catalyst containing decomposition chamber. These thrusters have the disadvantage that they are subject to engine wear; make use of high pressure poppet valves with limited cycle life; occupy a significant volume from aluminum/titanium fuel tanks, high pressure valves, and pipes; and provide limited resolution (several thousandths of a second fuel pulse) being limited by the speed of mechanical poppet valves.

For example, in one micro-chemical thruster for micro satellites based on a hydrogen peroxide thruster the finest resolution was limited to bursts of 80 μNs pulses. In a 20 cm×10 cm nano satellite with a mass of 5 kg this would create an end-over-end rotation speed in excess of 4 degrees/second making it impossible to finely adjust the attitude.

Another prior art attitude adjustment device is the Momentum Wheel or Reaction Wheel, which is based on an electric motor spinning a flywheel to achieve reactive angular momentum. While it can provide small angular adjustments, it cannot provide translational movement. It also tends to build up stored momentum that needs to be canceled, requiring supplemental attitude control systems.

Yet another attitude control system is the Control Moment Gyroscopes in which rotors are mounted on gimbals and spun at a constant speed. This provides a higher torque capability than a Reaction Wheels but is also more costly and heavier. Its complexity also makes the Control Moment Gyroscope more prone to failure (for instance, the International Space Station uses a set of four CMGs to provide dual failure tolerance). Yet another attitude control system involves the use of solar sails, which use the reaction force created by incident solar radiation allowing attitude and translational movement. Solar sales are beneficial in eliminating fuel and useful on long missions but are not suited to maintaining geostationary orbits.

A light, small and highly accurate micro-adjustment position controller for satellites would therefore be highly desirable to adjust for satellite drift or to position the satellite to perform a particular task, or simply to fine-tune attitude adjustments as provided by rockets or other systems currently used in the art of satellite attitude control

### SUMMARY OF THE INVENTION

According to the invention there is provided a satellite control system operable in a low pressure environment, comprising at least one substrate structure having a distal surface and a proximal surface with multiple holes extending at least partially into the substrate structure from the proximal surface, at least one heating element arranged at the bottom of the holes or at a predefined distance from the proximal surface, a liquid that is thermally ejectable from the holes by the at least one heating element, and at least one valve or cover, for selectively sealing the liquid from the low pressure environment. The liquid may be a non-volatile liquid. The system may include an electrical circuit that includes at least one controllable switch for controlling current flow to the at least one heating element. The control system may include a liquid supporting reservoir in flow communication with the holes in the substrate structure. The liquid is preferably a high-density liquid such as mercury. The liquid may also contain particulate matter. The at least one valve may comprise at least one micro-valve. The liquid may include ferrous particles and the at least on micro-valve may include a non-mechanical ferro-fluid valve. At least one of the micro-valves may comprise a piezoelectrically actuated micro-valve. The system may include pressure exerting means for exerting pressure on the liquid in the reservoir. The pressure exerting means may comprise a flexible balloon arrangement or plunger arrangement using a gas under pressure, e.g., nitrogen. The pressure is preferably controlled so as to limit the volume liquid flow rate into each hole due to the pressure differential and capillary action to one pre-defined ejection volume between ejections. The plunger or balloon arrangement may be connected directly or indirectly in flow communication with the reservoir. The substrate structure is preferably made from a material having a high operating temperature and low coefficient of thermal expansion and providing high thermal conductivity, a high heat capacity and a high thermal shock parameter, e.g. silicon carbide or any of its poly types (different atomic arrangements). These may for example include atomic arrangements such as cubic (4 C), hexagonal (4H and 6H), or rhombohedral crystal lattice arrangements. The holes formed in the substrate structure may have a ratio of diameter to the depth of the heating elements from the proximal surface of between 1 to 1 and 1 to 10. The holes may be 74 μm in diameter with silicon carbide streets between the holes that are for example 12 micrometers wide to provide a center to center distance between the holes of 86 μm.

The substrate structure and electric circuit may be implemented as a MEMS device (micro electromechanical system).

The control system may, further include a processor or controller for determining which holes, the number of holes, and/or the number of firings for such holes that is required for a particular attitude adjustment of the satellite in a particular time period. The control system may further include a radio receiver for providing signals to the processor defining an attitude adjustment or desired orientation. Preferably each hole is provided with a separate heating element formed at or near the distal end of each hole or around each hole and defining part of an electrical circuit that includes at least one switch. All of the switches may be controlled by the processor or controller.

Further, according to the invention, there is provided a method of controlling the position of a satellite, comprising ejecting a non-volatile liquid from a channel by thermal ejection. Typically the position control comprises an attitude adjustment of the satellite. The method may include ejecting from multiple channels. The channels may comprise holes formed in at least one substrate structure, e.g. a SiC substrate structure. The liquid may comprise a high density liquid such as mercury. The ejection of the liquid may be controlled by a processor. The holes may be pre-filled with the non-volatile liquid or filled prior to ejection. The holes may be filled from a reservoir and may be refilled one or more times after liquid has been ejected from the holes. The processor may control which holes to eject from, and the number of holes from which to eject, and may define the duty cycle of the ejections if any hole is required to eject liquid more than once. The holes may be formed by MEMS technology in a SiC substrate, the method comprising ejecting the non-volatile liquid from the holes in the substrate structure.

### BRIEF DESCRIPTION OF THE DRAWINGS

FIG. 1 shows a three dimensional view of a depiction of a substrate structure of a control system of the invention (not to scale),

FIG. 2 is cross-section through one embodiment of a substrate structure of the invention (not to scale),

FIG. 3 is a depiction of a 6 H hexagonal atomic arrangement,

FIG. 4 is a cross section through one embodiment of part of a control system of the invention (not to scale),

FIG. 5 is a cross-section through another embodiment of a control system of the invention (not to scale),

FIG. 6 is a cross-section through yet another embodiment of a control system of the invention (not to scale),

FIG. 7 shows a circuit diagram of one embodiment of an electrical circuit forming part of the control systems of the invention,

FIG. 8 shows a three dimensional view of a satellite with control systems in accordance with the invention,

FIG. 9 shows a top view of another embodiment of a substrate structure of a control system of the invention (not to scale),

FIG. 10 is a side view of the substrate structure of FIG. 9 (not to scale),

FIG. 11 shows a three dimensional view of an embodiment of a substrate structure with moveable cover for a control system of the invention (not to scale),

FIG. 12 is a top view of the structure in FIG. 11 with the cover in an open position,

FIGS. 13-21 show simplified depictions in cross-section of different prior art micro-valves,

FIG. 22 is a sectional view of part of another embodiment of a control system of the invention (not to scale),

FIG. 23 is a sectional view of part of yet another embodiment of a control system of the invention (not to scale), and

FIG. 24 is a circuit diagram of another embodiment of an electrical circuit forming part of the control systems of the invention

### DETAILED DESCRIPTION OF THE INVENTION

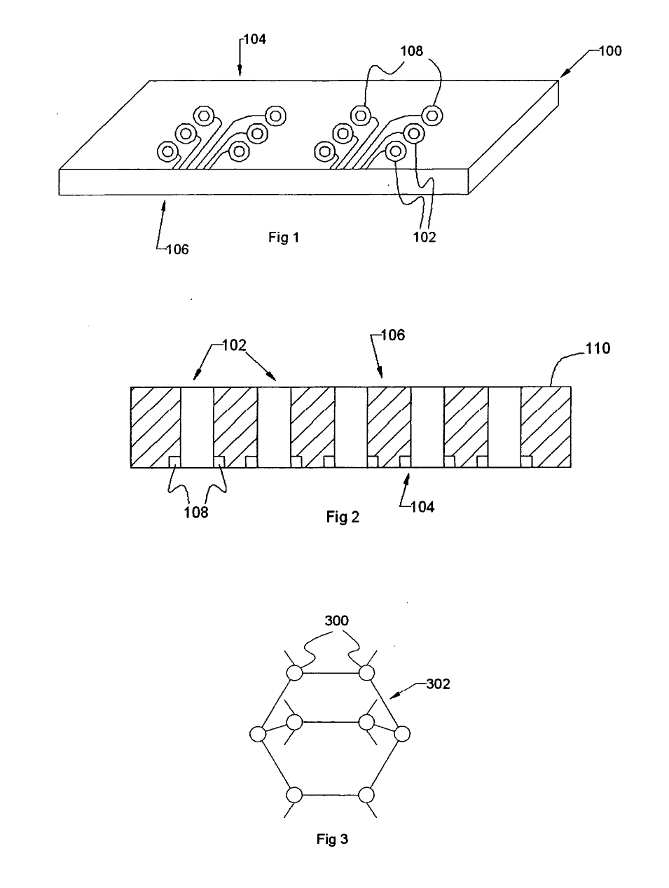

The present invention proposes a method and a means for generating controlled, small amounts of thrust in defined directions. Thus the invention relies on Newton's third law of motion: “For every action there is an equal and opposite reaction” to turn a satellite in space by generating a thrust in an opposite direction. This is achieved by thermally ejecting small amounts of liquid such as mercury, from one or more channels, in defined directions in a controlled manner. Due to conservation of momentum the momentum of the liquid droplet that is ejected (mass×velocity of the droplet) is reflected as an opposite momentum of the satellite. Thus, although the volume of the droplet is rather small, the combination of a high density liquid and a substantial velocity with which the liquid droplet is expelled translates into an appreciable momentum for the satellite. In one embodiment, a semiconductor substrate structure is formed e.g. by MEMS technology as shown in FIG. 1 to form the thermal ejector or droplet emitting device. A short overview of MEMS technology is therefore instructive in understanding the present invention.

MEMS (Micro Electromechanical Systems), also referred to as micro machines or micro systems technology, is a modified semiconductor device fabrication process that makes use of molding, plating, wet etching (KOH, TMAH) and dry etch (RIE and DRIE) and electro discharge machining (EDM) techniques to produce systems on a substrate in the micrometer range (typically 1-900 μm). While thin films can be thinner than 1 micron, in practice the structures that have a mechanical function need a minimum mass, and a minimum area. The upper end of the thickness range is determined by the thickness of standard wafers from which the die are made. MEMS fabrication lines make use of wafers that are up to 200 mm in diameter (referred to as 8″ wafers), having a thickness of 675 micron. Some MEMS substrate structures have, in the past, made use of die from polished glass wafers at a thickness of as much as 1 mm, which typically marks the upper limit of what is commonly called Micro Technology.

The fabrication of devices using MEMS technology typically involves the deposition of layers of materials, patterning of the layers by photolithography, followed by etching.

As indicated above, MEMS devices can be manufactured from a variety of material. Probably the most popular material for MEMS devices is silicon due to its inherent ability to incorporate electronic functionality. In its mono-crystalline form it displays almost no hysteresis when flexed, and thus virtually no energy dissipation. Also, unlike most metals it suffers virtually no fatigue when repeatedly stressed. Polymers can also be used in these processes and are suited to injection molding, embossing, and stereolithography. As alluded to above, metals can also be used but have physical limitations. On the other hand metals can be deposited by electroplating, evaporation, and sputtering processes. Commonly used metals include gold, nickel, aluminum, copper, chromium, titanium, tungsten, platinum, and silver.

MEMS devices may be provided with a central unit or microprocessor that communicates with peripheral units such as micro-sensors.

The present invention, in a preferred embodiment, makes use of MEMS technology to produce attitude control devices in accordance with the present invention. The embodiment of FIG. 1 shows a substrate structure 100 with multiple holes 102 etched or otherwise cut into the substrate structure. This can be achieved by any one of a number of commonly known techniques.

Bulk micromachining is the oldest technique for forming silicon based MEMS. In this approach the whole thickness of a substrate structure, e.g., a silicon substrate structure, is used for building the micro-mechanical structures. The silicon is machined using various etching processes, and additional structures, e.g., silicon structures or glass plates are added by anodic bonding to create features in the third dimension for hermetic encapsulation. This technique is also used for high performance pressure sensors and accelerometers.

Another technique involves surface micromachining which uses sacrificial layers deposited on the surface of a substrate as the structural materials, rather than using the substrate itself. Surface micromachining was created in the late 1980s to render micromachining of silicon more compatible with planar integrated circuit technology, with the goal of combining MEMS and integrated circuits on the same silicon.

Currently both bulk micromachining (of the order of 10-900 micron thick structures) and surface silicon micromachining (of the order of 1 micron thick structures) are used in the industrial production of sensors, ink-jet nozzles, and other devices. However, in many cases the distinction between these two processing techniques has diminished. A new etching technology, deep reactive-ion etching, has made it possible to combine good performance typical of bulk micromachining with comb structures and in-plane operation typical of surface micromachining. Reactive-ion etch is a form of high aspect ratio (HAR) silicon micromachining. In HAR silicon micromachining the aspect ratios are of the order of 1:10 to 1:100, which are a function of the precision of the physical effect, and of the chemical nature of the process. Reactive Ion Etching (RIE) can thus produce side wall angles better than 6 degrees [=tan(0.1)].

However, the critical dimensions of a structure are not limited only by the theoretical parameters that a process is capable of but are dictated also by transport phenomena, e.g. bringing etched material out of the hole.

As indicated above, MEMS technology borrows many of the process techniques used in semiconductor manufacturing. However, the consensus of the industry currently favors separate manufacturing of the mechanical and electronic components, with the option of subsequently bonding the two structures to one another. The flexibility and reduced process complexity obtained by having the two functions separated currently outweighs the small penalty in packaging.

In the embodiment shown in FIG. 1 only 12 holes are shown for illustrative purposes. However, several hundreds or even many thousands of holes may be formed in a die that defines the substrate structure. The complete control system may be made up of multiple die arranged in a matrix, each die defining a substrate structure with holes extending into it. For example, the proximal surface of the complete control system may be 6×6 inches in surface area. Typically the MEMS device will be formed from portions of a wafer that is cut into smaller pieces or die that are, e.g., 1 cm×1 cm in size. In order to achieve the 6 inch×6 inch size structure proposed in this embodiment, (6×2.54)²=233 such die would be required to provide the requisite size of the control system, which could be implemented as an array of 15×16 die for a total of 240 die. For purposes of this application, however, even though multiple die or substrate structures may be arranged together in a matrix to form the control system the set of die or set of substrate structures will also be referred to herein simply as the substrate structure. In this embodiment the substrate structure is shown upside down with its distal surface 104 and its proximal surface 106. As shown in the embodiment of FIG. 1, each of the holes 102 is provided with a heating element 108 surrounding the hole on the distal surface 104. Thus the MEMS device defines a disk-like substrate structure with multiple channels defined by the holes 102 extending in this embodiment from the distal to the proximal surface as shown in FIG. 2. In order to propel droplets of the liquid, e.g., mercury out of the channels 102, a disk-like cross-section of the liquid is rapidly heated to turn it into vapor in a uniform nucleation to form a bubble, thereby propelling or ejecting a liquid droplet located in front of the vaporized bubble, at high speed out of the channel by virtue of the rapidly expanding bubble, in a manner similar to that found in ink-jet printer technology. Thus the liquid need not be a volatile liquid, and is, in fact, typically not a volatile liquid. However, as is discussed in greater detail below, the non-volatile liquid that is thermally ejected is preferably a liquid of much higher density than water since the purpose is not to eject onto a surface but to generate a large amount of momentum. The substrate material is accordingly also chosen to have good physical, thermal and chemical parameters as is discussed in greater detail below. Also, since the device is intended to be used in a near vacuum environment of outer space, special adaptations have to be incorporated to avoid the liquid from being sucked out of the channels by the vacuum and to limit any evaporation of the liquid due to the low pressure of outer space.

The heating of the liquid for thermal ejection is achieved by one or more heating elements, which in this embodiment is formed around each hole. The heating elements 108, in this embodiment, are shown at the bottom of the channels on the distal surface. However, in another embodiment the heating elements are located at a predefined depth from the proximal surface, thereby defining the droplet size as defined by the depth of the heating element and the area of the hole or channels 102. In one such embodiment the heating elements are formed by depositing SiN rings and doping the SiN to form integrated high resistance structures. Intervening wafer material, referred to herein as roads 110, are formed between the channels 102.

In the above embodiment the holes or channels extend all the way through the wafer and the heating elements are formed around the holes. However, other configurations can be used e.g., channels extending into the substrate material or wafer from a proximal surface of the wafer to a predefined depth, with heating elements at or near the bottom of the hole. The device may be designed to be fired once only from each of the holes (either individually or simultaneously, but most commonly by calculating the number of holes that have to be fired in order to achieve a desired attitude adjustment of the satellite). The devices may also be designed to be refillable, for multiple ejections or firings from each hole. In the embodiment of FIG. 1, in which the holes extend through the wafer, the refilling may take place from the distal surface, e.g., by providing reservoir on the distal surface of the wafer, in flow communication with the channels. The replenishing of the channels in another embodiment takes place by means of lateral channels in flow communication with the ejection channels. In one embodiment, the heating elements are formed as rectangular resistive elements at the bottom of the holes and insofar as additional liquid is supplied to the holes to facilitate replenishing of the liquid in the holes, the replenishment channels extend laterally into the substrate material to the holes at a level above the heating elements.

While much of MEMS technology is based on fabrication using silicon, the present invention proposes the use of materials having a much higher operating temperature and lower coefficient of thermal expansion and providing high thermal conductivity, a very low heat capacity and a high thermal shock parameter. In particular the present application proposes the use of silicon carbide or any of its poly types (different atomic arrangements). In the present embodiment the wafer is made from silicon carbide having a 6H crystal lattice configuration.

Silicon carbide (SiC), also known as carborundum, is a compound of silicon and carbon with chemical formula SiC. The grains of silicon carbide can be bonded together by sintering to form very hard ceramic plates, and SiC is widely used in high-temperature/high-voltage semiconductor electronics. As mentioned above, while SiC always involves a combination of silicon and carbon, the crystal lattice structure may vary and includes structures such as 3 C (cubic) atomic arrangements with the atoms located at the corners of cubes forming a lattice structure, or a hexagonal (4H or 6H) arrangement that repeats every four or six layers, or a rhombohedral arrangement. A comparison of the arrangements and properties of 3 C, 4H and 6 H are given in the table below.

| Polytype | 3C (β) | 4H | 6H (α) |
|---|---|---|---|
| Crystal structure | Zinc blende | Hexagonal | Hexagonal |
| | (cubic) | | |
| Space group | T²_{d}-F43m | C⁴₆ᵥ-P6₃mc | C⁴₆ᵥ-P63mc |
| Pearson symbol | cF8 | hP8 | hPl2 |
| Lattice constants (Å) | 4.3596 | 3.0730; | 3.0730; |
| | | 10.053 | 15.11 |
| Density (g/cm3) | 3.21 | 3.21 | 3.21 |
| Bandgap (eV) | 2.36 | 3.23 | 3.05 |
| Bulk modulus (GPa) | 250 | 220 | 220 |
| Thermal conductivity | 3.6 | 3.7 | 4.9 |
| (W/(cm · K)) | | | |

While silicon is used in one embodiment of the invention, SiC offers several benefits that make it the preferred material for the MEMS substrate material.

SiC is in many ways more robust than silicon, both thermally and mechanically:

A. Thermally

SiC offers a higher thermal shock parameter resulting in slower development of crystalline fault formation, macroscopic cracking and migration pit formation. This allows it to withstand higher temperature cycling, allowing it to provide for greater mass ejection speed of the liquid.

SiC has approximately 3 times higher thermal conductivity (depending on the crystal lattice arrangement of the SiC), and about a 16 times lower thermal capacitance, than silicon. This provides for rapid heat dissipation after ejection, ensuring greater control over the duty cycle (rate of firing). It also provides improved thermal spreading to achieve greater thermal uniformity for maintaining the device at the desired viscosity temperature for the liquid being ejected (typically liquids display different viscosities at different temperatures and thus the ease with which it ejects from a channel is a function of its temperature).

B. Mechanically

The physical robustness of SiC ensures slower development of crystalline fault formation, macroscopic cracking and migration pit formation than Si, and thus suffers less degradation due to the outward pressure-pulse shock fronts, and less side-wall erosion due to the outward flow that follows, and perpendicular turbulence resulting from the thermal ejection process. Since SiC suffers less pitting, it is less vulnerable than silicon to the formation of local bubble nucleation sites within the initial vaporization disk (one result of which is increased turbulence), and will also develop less additional wall interface friction, and consequently less age degradation of the ejection speed and colinearity. The physical robustness of SiC also provides additional resilience against ballistic damage from micro-meteorites.

Other embodiments of the invention makes use of SiN, AlN (Aluminum nitride), GaN, AlGaN, GaAs, or other single or poly crystalline materials, with a preference for single crystalline material to form the substrate structure. Control devices of the invention may include combinations of materials, e.g., Si, SiC, SiN. For example, the substrate structure that supports the ejection holes may comprise SiC while any other elements of the control system, e.g., covers, lids, reservoirs, micro-valves, could be made from a different material such as Si or SiN. Even an individual element of the control device may comprise more than one material, e.g., SiC or SiN can be epitaxially grown on Si, or SiN; or SiC can be epitaxially grown on SiC to form the substrate structure or one of the other elements of the control device.

In one embodiment AlN was grown on SiC to form substrate material for the substrate structure. In another embodiment SiC was grown on Si and in yet another embodiment SiC was grown on SiC to form the substrate material of the substrate structure.

Different embodiments were tried with holes ranging in diameter from 30-100 um and with the depth of the fluid column being of the order of 50 um to 100 um. Embodiments are not however limited to these hole configurations. In one embodiment, discussed in greater detail below, the holes formed in the wafer have a radius of 37 μm and are formed in a wafer that has been micro-machined to a thickness of 74 μm. The holes are formed with intervening streets of 12 μm for a center-to-center distance of 86 μm.

In order to determine the ideal hole aspect ratio for any particular liquid, empirical data is required for the various liquid parameters (density, viscosity, latent heat, and boiling point) and the power supply available. For example, for water based substances such as ink, it has been found that holes with aspect ratios of 1:1 to 1:3 (channel diameter to channel depth) work well in thermally propelling the liquid from the holes.

It will be appreciated that viscosity and channel diameter will determine refill rates due to capillary attraction and differential pressure across the column of liquid. Once the liquid is in the channel, its specific gravity and viscosity (which defines how easily the fluid flows in the channel) will determine the force needed to eject a droplet of a particular size (due to the varying mass with varying specific gravity). The requisite force generated is, in turn, related to the power source that is available and the resistivity of the heating element since the power P dissipated in a resistive element is related to the resistance R of the resistive element and the current I flowing through it, according to the formula P=I²R. However the amount of heat energy required in order to expel a droplet of liquid by thermal ejection depends also on the rate with which the liquid can be brought to its vapor phase. For example, even though mercury has a boiling point more than 3 times that of water, its latent heat is only about 1/10 of that of water and therefore heats up to phase transition far more rapidly than water, making it an ideal candidate for purposes of the present invention. Also, mercury has a viscosity that is only about 1/10 of that of water, making it far easier to eject from a channel. The benefits of mercury over water as a non-volatile ejection liquid may be summarized as follows:
Mercury has a kinematic viscosity of only about 7% to 31% of that of water, depending on its temperature.
The latent heat to bring 1 gram of mercury to boiling point is only 342 Joules compared to water requiring 2592 Joules: a 7.6× benefit.
The density of mercury is 13.57× that of water for a much improved momentum to volume ratio.
Mercury provides for a higher channel refill rate with resultant higher duty cycle due to lower viscosity.
The lower viscosity of mercury also results in reduced wall friction and a resulting lower ejection energy requirement.

Considering again the embodiment with holes having a diameter of 74 um and a depth of 74 um, and assuming that droplets of thrust-producing liquid e.g. mercury are emitted from each of the holes using heating elements located at the distal ends of the holes, the volume of material in each hole will be JI r²×t=JI (37²×74)×10⁻¹⁸=3.18×10⁻¹³ m³=318 pl (pico liter). The amount of area (hole and surrounding street area) for each unit or hole is thus (37+12+37)² μm²=7.396×10⁻⁹ m². Thus in a wafer of 6 inch×6 inch=6.45×3.6×10⁻³ m² this provides for a total of 4.867×10⁵=3,140,000 holes for a total Mercury volume in the holes of approximately 10⁻⁶ m³=1000 μl=1 ml.

It will be appreciated that droplet volume will vary depending on the hole diameter and length, and will depend also on the surface tension, density, and viscosity of the liquid being ejected. By way of example, for hole diameters chosen to be equal to the hole length (ratio of 1:1), hole diameters of 5 μm, 15 μm, and 38 μm, provide droplets with a volume of 0.1 picoliter (one millionth of a microliter), 2.7 picoliter and 44 picoliters, respectively. The choice of hole depth (or location of the heating element from the proximal surface of the wafer) and hole diameter will depend on the density and kinematic viscosity of the liquid. As the length of liquid that is propelled out of the hole increases, the mass increases for the same amount of force exerted by the heating element thereby reducing the velocity of the propelled droplet. On the other hand the hole cannot be made too wide since the propulsion of the liquid requires vaporization of a disk of material beneath the liquid that is to be expelled.

Modeling software has been developed from empirical data for the ejection of ink droplets.

Similar software models can be developed for the various other liquids contemplated for the attitude control system, based on empirical data using different hole widths and depths, different hole aspect ratios (side-wall slope), and heating element resistances for the power supplies available in the various satellites in which the device is to be implemented.

One embodiment of the invention makes use of a capacitor to charge up from a low voltage power supply. The low internal resistance of the capacitor allows a large current to be released to the heating elements for a short period of time as the holes are fired (i.e., when the liquid in the holes is to be thermally ejected). For a capacitor, Q=CV where Q is charge, C is capacitance and V is voltage potential of the charged capacitor. The capacitor allows a current I to be discharged over a period t according to the equation I=Q/t

It will be appreciated that larger heating elements and larger energy sources can be used insofar as larger energy sources are available. In one embodiment a nichrome resistor was chose as the heating element and a voltage of 12V was applied to the nichrome wire as energy source. Nichrome at 38 gauge (0.004 inch diameter) has a resistance of 42.2 Ω/ft. In practice a heating element could be deposited with much smaller dimensions and correspondingly higher linear resistance. In the case of mercury, in order to avoid the mercury reacting with the heating element a substance that will not form an alloy with mercury is desirable, such as Tungsten or silicon nitride doped to provide the desired conductivity.

As will be discussed in greater detail below the mercury or other liquid in the holes may be replenished from a reservoir to permit multiple firings from each hole.

In the above embodiment a hole diameter of 74 μm was chosen, which provides for reasonably large drops of liquid. Such larger holes are particularly suited to the use of mercury as the liquid to be expelled. The high density (specific gravity of 13.57) allow for small, heavy droplets. Also, the high surface tension of mercury requires that the hole size cannot be too small. As is mentioned above, the additional benefit of mercury is that its viscosity is much lower than water, and at about 0.11 centistokes makes it much more slippery and easier to expel. Thus, as will become clearer from the discussion below the use of large holes requires more energy in order to expel or shoot out the droplets, however this is helped by the low wetting coefficient of mercury allowing it more easily to be released from surfaces that it is in contact with. The use of larger holes has the advantage of larger drops with higher mass and therefore higher momentum. In order to ensure that the velocity of ejection is not too severely curtailed by the larger mass, a higher resistance heating element and a larger power source (or the addition of a capacitor as discussed above) may be provided to achieve greater heat dissipation into the liquid. Thus mercury offers some clear benefits in the device of the invention that seeks to produce thrust in order to achieve a reactionary force for purposes of attitude adjustment. As discussed above, by the conservation of momentum, the larger the mass and velocity of the emitted droplets, the larger the momentum and consequently the larger the velocity with which the satellite will be propelled in the opposite direction. It is proposed that droplet sizes of the order of 50 to 300 pl be expelled from a substrate structure with ratio of hole diameter to substrate structure thickness of, for example, 1:1 to 1:10. Some embodiments of the control system may include die with different hole sizes or the matrix of die can have different hole sizes, with each die dedicated to a particular hole size. For simplicity the embodiments discussed below show substrate structures with only a few holes, each of the same depth and diameter.

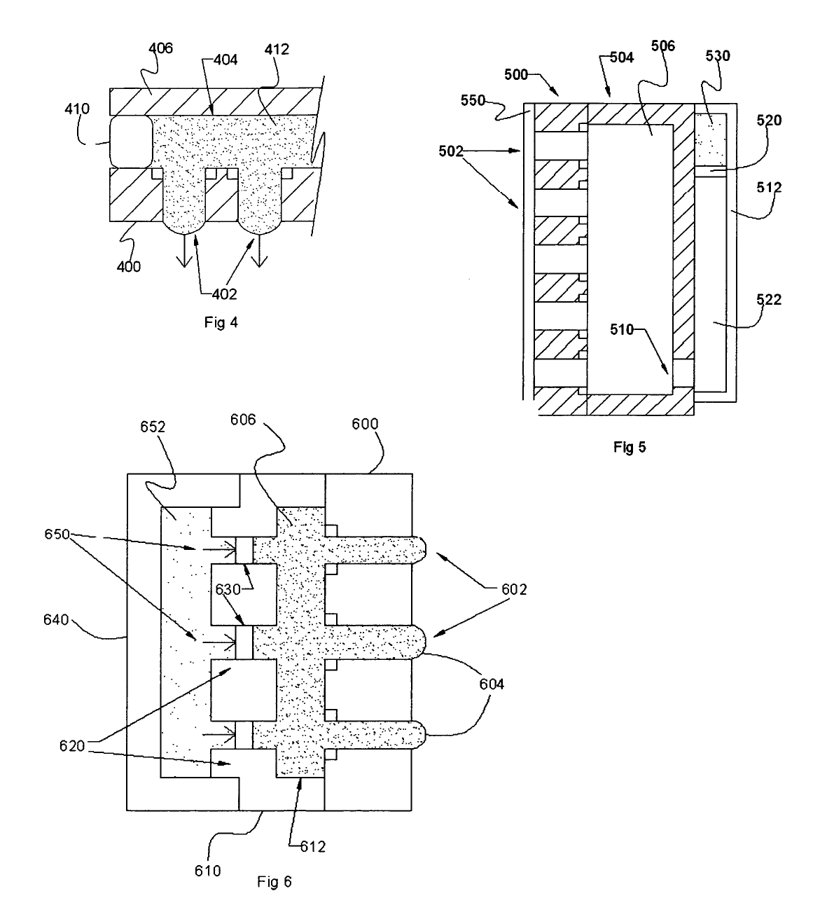

A cross-section through one such embodiment is shown in FIG. 4 in which the substrate structure is oriented vertically and indicated by reference numeral 400 with holes 402 extending through the substrate structure 400 and showing the heating elements 404. A mercury reservoir 404 is created between the substrate structure distal surface and a distal plate 406 that in this embodiment is made of the same material as the substrate structure 400, i.e., silicon carbide. In this embodiment a nitrogen-filled flexible bladder 410 (e.g., a polymeric balloon-like bladder) is formed at one end of the structure to exert air pressure on the mercury 412 due to the lack of atmosphere in the environment in which the satellite will be operating. The bladder may be secured to the substrate structure by any suitable bonding technique for the material, e.g., silicon fusion bonding, anodic bonding between silicon and glass, or eutectic bonding where metal such as platinum is introduced between the two Si layers. The polymeric bladder may, instead of exerting a positive pressure on the liquid, be configured to provide a back pressure on the liquid to prevent the liquid being sucked out too rapidly by the near vacuum environment of outer space, which is discussed in greater detail below). By providing the polymeric bladder with an inherent convex shape or memory it will create a back pressure on the liquid. The negative differential pressure caused by the near vacuum environment of outer space can be relied upon, in conjunction with capillary attraction between the liquid and the channel walls to transport the liquid toward the proximal face of the substrate structure that is exposed to the environment. The opposite side of the substrate structure and the other two sides of the square or rectangular substrate structure in this embodiment may include similar flexible bladders or may simply be sealed e.g. by silicon carbide material. The size, type of gas in the bladder, and pressure exerted on the gas in the bladder is chosen to allow the full amount of mercury to be gradually transported into the holes to replenish the holes as mercury droplets are ejected from the proximal surface of the substrate structure.

The use of the device in the outer space environment brings with it additional difficulties, apart from the near vacuum environment, which seeks to suck the liquid out of the channels.

The low pressure also causes liquids exposed to the environment (for example the mercury in the channels to evaporate. Since a satellite may have a life-span of the order of 30 years it is therefore desirable to seal the mercury in its holes until it is ready to be fired or seal the mercury in a separate reservoir or chamber prior to filling the channels or holes. The sealing may be achieved by providing a plug over the hole openings or providing a layer of SiC over the proximal surface to seal in the liquid.

It will be appreciated that such an embodiment will be useful only where all of the mercury is to be fired once the plug or cover is removed e.g., all holes are single fire holes or are fired repeatedly until the mercury is depleted. Insofar as each hole is provided with its own plug, this approach allows the holes to be fired individually or in groups as needed. One such embodiment is shown in FIG. 5, which shows the layer 550 covering the substrate structure 500.

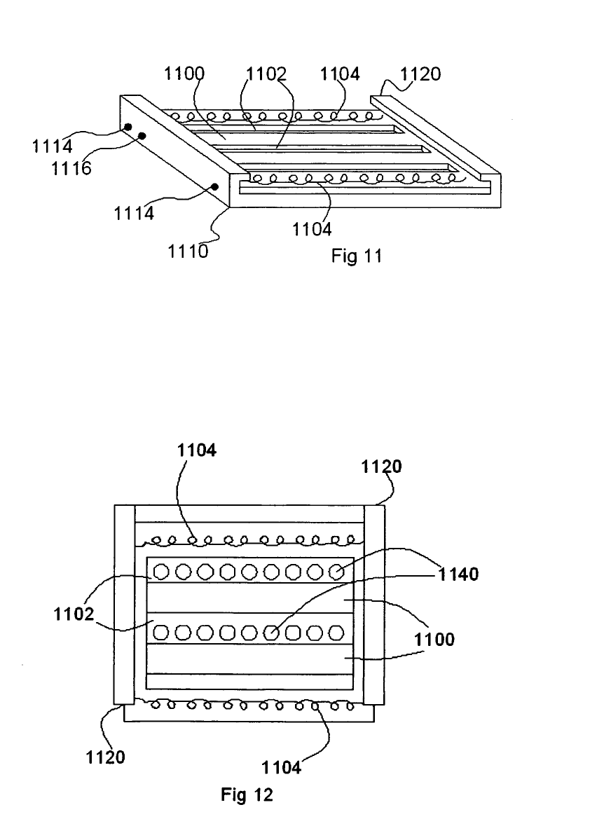

In another embodiment, shown in FIG. 11, a moveable cover is provided over the proximal end. In this embodiment the cover takes the form of a SiC disk having parallel extending slots 1102 with intervening portions 1100 like the tines of a fork or comb. The disk 1100 includes coils 1104 along two of its sides that are coupled to a DC power source to define electromagnets. The substrate structure 1110 is also provided with similar electromagnets 1114 thereby allowing the magnets 1104, 1114 to either attract each other (thereby sealing the hole openings by having the tines 1100 of the SiC material of the disk coincide with the hole openings 1112) or repel each other to lift the disk 1100, depending on the polarity of the electromagnets 1104, 1114. In addition to the coils 1114 along the sides of the substrate structure 1110, the substrate structure includes a second set of electromagnets 1116 that are polarized to attract the electromagnets 1104 when the disk is repelled by the electromagnets 1114. This ensures that the disk is shifted laterally to align the slots 1102 with the hole openings as shown in FIG. 12, thereby exposing the holes 1140 for firing. In order to ensure that the disk 1110 is not lost, it is retained in rails 1120 extending upward along the sides of the substrate structure. It will be appreciated that the disk or closure member could be made of different materials and moved using different mechanisms and could rotate or pivot in order to expose the holes. The advantage of a moveable closure member or disk is that a larger amount of liquid material such as mercury could be retained in the device for repeated firing over time from the same holes. It also allows only some of the holes to be fired and the number of firings and duty cycle to be varied depending on the nature of the satellite adjustment required.

It will also be appreciated that in the embodiment of FIG. 11, the width of the tines 1100 is preferably a little larger than the diameter of the holes in the substrate structure to ensure that the holes are covered when the cover is in its closed position. Also, the roads between the holes of the substrate structure have to be wide enough to accommodate the tines when the cover is it its open position as shown in FIG. 12, to avoid the tines 1100 from interfering with the mercury or other liquid as it is ejected.

In a preferred set of embodiments, micro-valves are used to seal off the liquid from the outer space environment. The micro-valves, in one embodiment seal off the liquid in a separate chamber or reservoir shortly before filling the firing holes or ejection channels, e.g., less than a minute prior to ejection (firing) of liquid from the channels, to minimize loss of mercury due to evaporation. Since the vacuum of outer space will tend to suck the liquid out of the channels, the differential pressure across the liquid in the channels has to be controlled and preferably is controlled to ensure that the ejection takes place once the channel has been filled. Thus the differential pressure and corresponding speed with which the channels or holes are filled has to be controlled to allow a processor to time the ejections of the fluid from the channels.

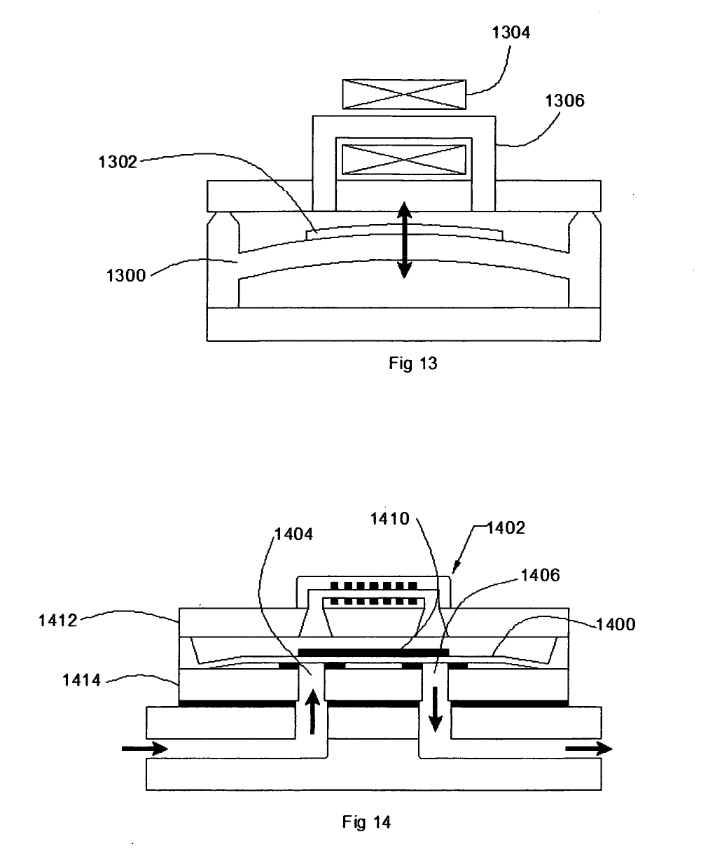

Several such micro-valves have been developed in the art and some of these are discussed below with respect to FIGS. 13-21.

Micro-valves can be categorized as active (in which their open/closed configuration is manipulated by an external actuator) or can be categorized as passive.

The micro-valves can best be considered as falling into three groups: (a) mechanical, (b) non-mechanical and (c) external, based on their actuation mechanism.

(a) Mechanical micro-valves are typically surface or bulk micro-machined MEMS devices with a mechanically moveable membrane or micro-ball that is coupled to a magnetic, electric, piezoelectric or thermal actuation mechanism. An example of a magnetic actuation mechanism is a solenoid plunger.

(b) Non-mechanical micro-valves are actuated by virtue of their smart materials, e.g., phase changing or rheological.

(c) External micro-valves are actuated by external modular or pneumatic means.

FIG. 13 shows an electromagnetically actuated active micro-valve in which a mechanical membrane 1300 is provided with a layer of permalloy 1302, which is attracted by an electromagnet defined by coils 1304 wound around a core 1306. The operation of an electromagnetically actuated micro-valve is best appreciated with respect to FIG. 14, which shows another embodiment of a magnetically actuated micro-valve. As the membrane 1400 is bowed upward by the magnetic force of the electromagnet 1402, the seal created by the membrane 1400 on the valve seat over the inlet and outlet openings 1404, 1406 is lifted to provide flow communication between the inlet and outlet. The magnetic inductor or electromagnet 1402, valve components (comprising the silicon or silicon carbide membrane 1400 with its NiFe permalloy thin film 1410, and the silicon or silicon carbide cover 1412), and the glass motherboard were fabricated separately and then bonded together by low temperature bonding. Tests conducted on the structure of FIG. 14 found a leakage flow rate of 10.5 μl/minute at 8.3 kPa, and a leakage flow rate of 3.9 μl/minute at a pressure of 4.1 kPa.

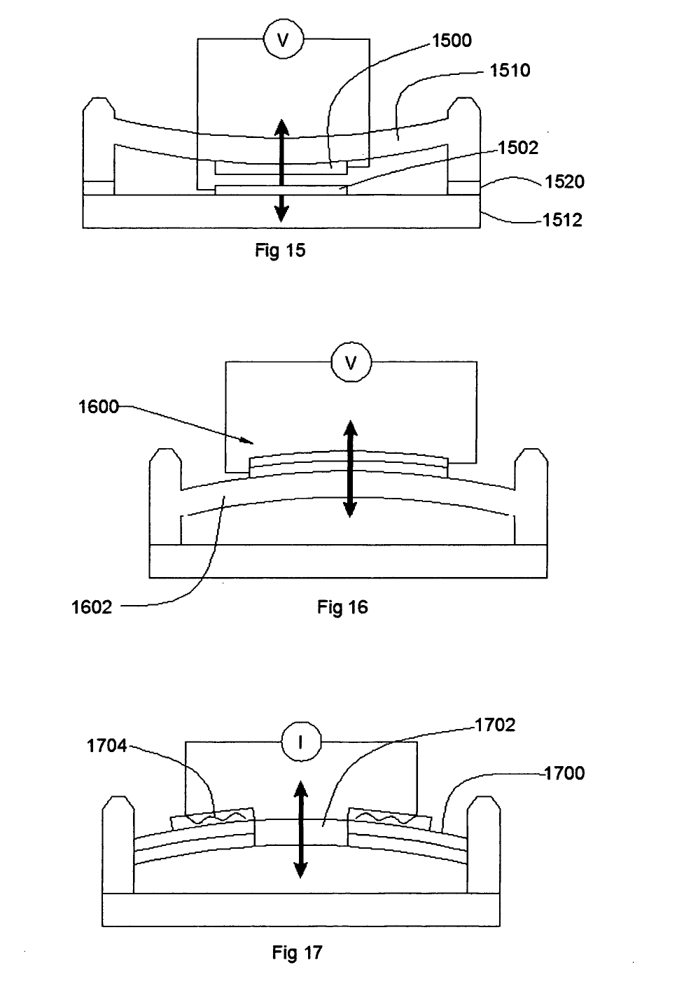

FIG. 15 shows an active electrostatically actuated micro-valve in which a voltage is applied across two plates 1500, 1502 formed on a membrane 1510 and base 1512 to create an electrostatic attraction between the plates and cause the membrane to be attracted to the base. Insulating spacers 1520 prevent discharging of the electrostatic charge. In one embodiment of an electrostatically actuated micro-valve the micro-valve was opened against a pressure of 900 kPa using a voltage of 136 V to create a flow rate of 45 ml/min. At an upstream pressure of 170 kPa helium leakage rate was measure at 6 μl/minute.

FIG. 16 shows a piezoelectric actuation mechanism in which a voltage is applied across a bimetallic strip 1600, causing it to deform as shown, thereby causing the membrane 1602 on which the piezoelectric device 1600 is formed to bow outward causing the membrane 1602 to be lifted off its valve seats (not shown). In one piezoelectrically actuated micro-valve a normally closed valve was created from a piezo stack 8.4 mm×5 mm×4 mm bonded on a silicon valve component. This produced a virtually leak-proof seal with a helium leakage flow rate at 550 kPa of only 5 ul/minute. In another piezo activated micro-valve making use of a voltage of 140 V the leakage flow rate was as low as 0.002 μl/minute at a pressure of 1 kPa. Thus for purposes of the present invention controlling the differential pressure across the liquid and using a piezo actuated micro-valve to separate the liquid from the ejector holes would ensure minimal evaporation due to the minimal leakage of the liquid into the channels. Thus it would reduce the evaporation to extremely low values of about 30 ml over 30 years insofar as the particular application requires a large number of course attitude corrections that make the addition of a reservoir a necessity. As discussed below, the number of attitude adjustments needed for a particular application may instead be adequately met by a pre-filled, self-contained substrate structure device that relies only on the mercury in its channels and has no separate replenishment reservoir. As mentioned above, such pre-filled channels have to also be sealed from the environment to prevent evaporation. This may, for example, be achieved by making use of a non-mechanical valve in the form of a paraffin plug, an electro-rheological fluid that changes consistency when and electric field is applied to it, or a ferro-fluid that contains ferrous particles to create a ferrous plug by selective magnetic attraction of the ferrous particles in the fluid, as discussed below.

FIG. 17 shows a mechanical micro-valve making use of bimetallic strips 1700 connected by a membrane 1702 and heated by resistive elements 1704 to cause differential thermal expansion and thus bowing to again lift the membrane away from valve seats (not shown).

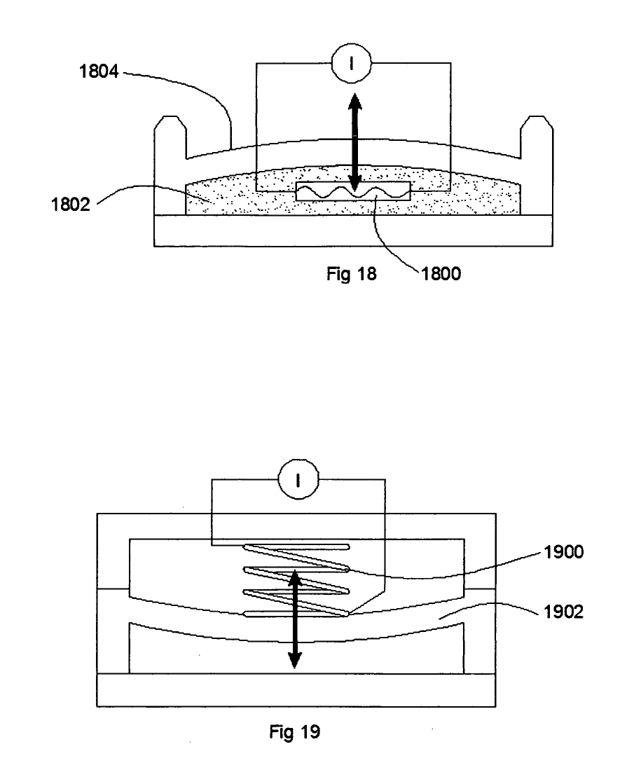

FIG. 18 is a thermo-pneumatically actuated device in which heating elements 1800 heat a fluid in a chamber 1802 to cause it to expand and deform a membrane 1804.

FIG. 19 shows a shaped memory alloy actuator 1900 which expands when a current is passed through it, to deflect a membrane 1902.

The covers, shutters or mechanical micro-valves used for sealing the liquid from the low pressure environment may be formed using MEMS technology and may be made of Si, SiC, SiN, or other suitable materials, and may be bonded to the substrate structure.

An example of a non-mechanical micro-valve is an electromechanical valve in which a flexible membrane is deflected by generating oxygen gas by electrolysis in a chamber bounded by the membrane.

In another non-mechanical micro-valve a smart hydrogel volume is changed by inputting a change in pH, temperature, electric field, light, carbohydrate, antigen, or glucose.

In yet another non-mechanical micro-valve the phase change nature of a paraffin material is used to create a reversible or irreversible seal by melting away a plug blocking a channel. It can be used together with external air or vacuum system to make the seal reversible, i.e., turn it to liquid and remove it as a plug and then use external air or vacuum to move the paraffin material back into place and change it back to a solid. The phase transition may be activated by thermal heating. The advantage of this micro-valve was that even at a pressure of 1725 kPa no leakage was detected over a 15 minute period, thus making it good candidate as a seal or at least as supplemental seal together with a main seal such as a piezoelectrically actuated mechanical seal.

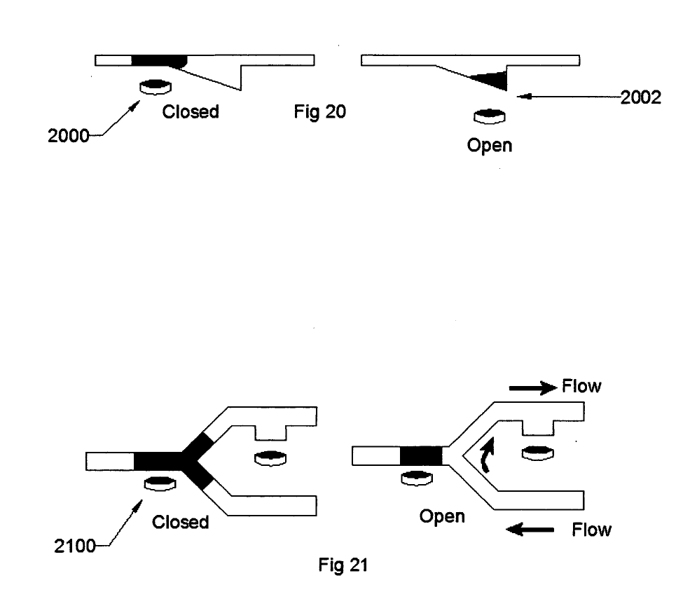

A similar micro-valve to the above paraffin micro-valve is an electro-rheological fluid which changes viscosity under the influence of electric fields. Another non-mechanical micro-valve that could be used with mercury is a ferro-fluid type device in which ferromagnetic particles of 10 nm size are suspended in a carrier fluid, e.g., mercury (since mercury does not react with iron). Two embodiments of such a micro-valve are shown in FIGS. 20 and 21. In FIG. 20 a magnet 2000 keeps the ferrous material in the path of the fluid flow to create a plug. When the valve is to be opened the magnet field is moved to a well 2002 to effectively open the channel to fluid flow. In FIG. 21 a y-valve is shown in which the magnetic field moves from the neck 2100 (when the valve is closed) to a location away from the neck (to open the valve for fluid flow from one leg to the other of the y).

The choice of closure member for the device may therefore vary depending on the type of liquid, the hole and reservoir arrangement, and the duration for which the device is to be used. For example some satellite adjustments or re-positioning may be severe and require a large burst, while others may require only fine-tuning or micro-adjustments to the satellite's attitude. Also the lifespan of satellites may vary, which affects the amount of attitude adjustments over its lifetime and the amount of evaporation of the liquid.

In one embodiment, shown in FIG. 5, the substrate structure 500 with its holes 502 is secured to a hollowed-out substrate 504 which, in this embodiment is also made of silicon carbide to define a housing with a cavity 506 between the substrate structure 500 and the housing 504. The cavity, in its operative state is filled with mercury. As shown in FIG. 5, an inlet channel 510 is formed in a wall of the housing 504 to provide liquid communication with a piston arrangement defined by a second housing 512 that is defined by a hollow-out substrate member. The housing 512 includes a plunger 520 that separates a mercury chamber 522 from a pressurized gas section filled with a gas under pressure such as nitrogen 530. During manufacture the housing 504 and housing 512 are filled with a liquid such as mercury, and nitrogen is sealed under pressure into the region depicted by reference numeral 530. The housing 512 with its plunger 520 therefore defines a piston arrangement that exerts a pressure on the mercury in the structure and ensures that the holes 502 are replenished as the mercury is fired from the holes 502.

In the above embodiment, in which mercury is used, with its low viscosity, it will be appreciated that the pressure exerted on the mercury cannot be too high in order to avoid it being squeezed out of the holes at too high a rate (a rate that exceeds the duty cycle or firing rate of the holes) as a result of the near vacuum conditions on the proximal end of the holes.

In an atmospheric environment, the height of liquid in a tube due to capillarity or capillary attraction can be expressed as

h=2σ cos θ/(ρgr)

where:
h=height of liquid (ft, m)
σ=surface tension (lb/ft, N/m) (which for mercury is 0.465 N/m)
θ=contact angle
ρ=density of liquid (lb/ft³, kg/m³) (which for mercury is 13.5×10³ kg/m³)
g=acceleration due to gravity (32.174 ft/s², 9.81 m/s²)
r=radius of tube (ft, m)

Thus the height h will be infinite when acceleration due to gravity (g) is zero. Thus, in space where the force of gravity is matched by an equal and opposite centripetal force due to the angular velocity of the satellite, a sense of weightlessness is experienced which fails to contain or pull down the mercury or other liquid in the tubes or holes. Therefore only a slight pressure differential is required across the tubes or holes to cause the mercury, in effect to be sucked out of the holes.

In order to address this issue, the present invention provides for the cover over the top of the structure or a micro-valve controlling the flow of liquid into the channels, as is discussed in above. Thus the cover or micro-valve arrangement serves not only to avoid evaporation of the liquid in a near vacuum environment but also addresses the problem of the liquid being sucked out of the channels by the differential pressure. In the case where the channels are filled just prior to firing, the timing of the firing can be synchronized to correspond to the channel fill time, taking into account the pressure differential across the channels and the kinematic viscosity of the liquid.

It will be appreciated that in order to address the issue of pooling of the liquid channels, reservoirs or tanks in which the liquid is kept initially have to be entirely filled. As the satellite is launched into space, gravitational acceleration and the acceleration of the space craft carrying the satellite act upon the liquid and cause it to accumulate in one area unless it is air gaps are eliminated e.g. by containing the liquid in a stretchable bladder.

Yet another embodiment of the invention is shown in cross-section in FIG. 6 and includes a substrate structure 600 with holes 602, which in this embodiment are charged with mercury 604. Again a reservoir of mercury 606 is formed adjacent the distal surface of the substrate structure 600 by means of a hollowed-out substrate member defining a housing 610 with a cavity 612 for housing the mercury 606. In this embodiment multiple holes or channels 620 extend through the floor of the housing 610. The channels 620 are provided with plungers 630 to define pistons. A second housing 640 with central cavity is secured to the housing 610 and is provided with a gas such as nitrogen under pressure to exert a force on the plungers 630 as depicted by the arrows 650.

As discussed above, in order to eject mercury droplets from the holes or channels in the substrate structure the heating elements such as the elements 108 shown in FIGS. 1 and 2 are rapidly heated to vaporize a thin layer of the liquid (e.g., the mercury), to create a bubble of vaporized liquid that pinches off the mercury in the channel and effectively shoots the mercury droplets on the proximal side of the bubble, out of the hole due to the force generated by the expanding vapor bubble.

As mentioned above, the present invention makes use of a substrate structure material such as SiC, with a high thermal shock parameter. The thermal shock parameter is given by the equation:

RT=(Hσ_{T}(1−μ))/αE

Where H is the thermal conductivity, σ_{T} is the maximum tension the material can resist, μ is Poisson's ratio, α is the thermal expansion coefficient, and E is Young's modulus.

As discussed above, each heating element will heat a section of the liquid in the hole to define a disk of heated liquid that will be turned into its gaseous phase to define a bubble. In order to effectively eject the droplet of liquid the heating of the layer of liquid to its vaporization point (nucleation) has to take place extremely quickly (more than 1 million degrees C./second) to form a bubble within a 10 μs time-frame.

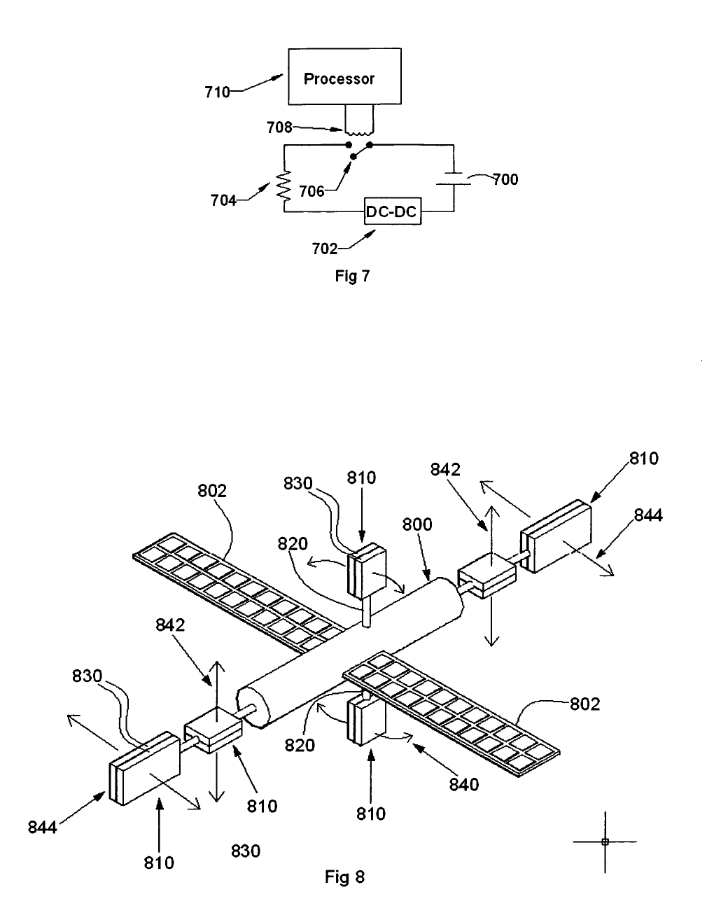

One embodiment of an electrical circuit controlling the firing of a mercury droplet is shown in FIG. 7. An electric power source in the form of a battery 700 is connected in series with a DC to DC converter 702 for generating the necessary voltage across the heating element 704. A controllable switch 706 in this embodiment takes the form of a relay that includes a solenoid 708 controlled by a processor 710. While FIG. 7 shows only one resistive element 704 and one switch 706 controlled by the processor 710, it will be appreciated that the processor 710 preferably controls each of the heating elements formed around the substrate structure holes. Thus the processor can control which holes and how many holes to fire in order to achieve a desired reactive force as defined by Newton's third law of motion. In another embodiment, the DC to DC converter 702 may be replaced by a capacitor to accumulate charge that can subsequently be rapidly dumped across the heating element 704 as a high current when the liquid is to be thermally ejected. In the embodiment of FIG. 7 the duty cycle (on/off switching of the heating element 704 is controlled by the processor 710, which controls the solenoid 708.

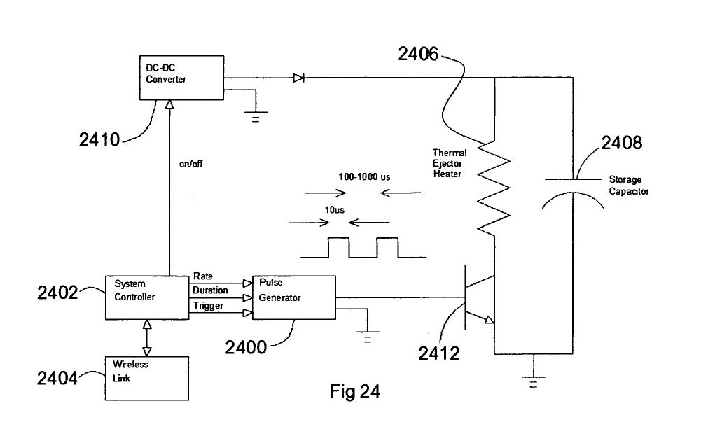

Instead, as shown in FIG. 24, a pulse generator 2400 can be used to generate a series of heating pulses. The pulse generator 2400 is connected to a system controller 2402 that controls the triggering, pulse duration and pulse rate of the pulse generator 2400. A wireless link 2404 to the controller 2402 allows attitude control information to be submitted to the controller for calculating the number of holes to be fired and the number of firings. Power to the heating element 2406 is provided by a capacitor 2408, which is charged by the controller 2402 via a DC-DC converter 2410. Thus, current for the heating element 2406 is provided by the capacitor 2408, and current flow is controlled by an NPN transistor 2412 that serves as series connected switch and is controlled by the output from the pulse generator 2400. As in the embodiment of FIG. 7, the heating element 2406 represents multiple heating elements that can be individually controlled by transistor switches 2412.

By controlling the number of firings per hole and the number of holes that are fired, the satellite control system can be standardized for a range of different sized satellites. The effect of using a standardized control system with a larger satellite is simply that the attitude adjustment will either be slower for the same number of firings or will require more holes to be fired or a greater number of successive firings from the holes in order to achieve the same effect as for a smaller satellite.

A typical satellite is shown in three dimensions in FIG. 8 and includes a satellite body 800 with solar panels 802. In this embodiment eight sets of attitude control structures 810 are secured to the satellite by means of elongate ribs or outriggers 800. As shown in FIG. 8 all of the control structures 810 are not of the same size. However, in this embodiment each structure 810 includes two attitude control devices 850 mounted back-to-back with their distal surfaces facing each other. This allows mercury to be fired outwardly in opposite directions, thus allowing the attitude of the satellite to be adjusted and once the desired position is attained, to fire in the opposite direction to stop the movement. In particular, the satellite can be rotated about a rotational axis as depicted by arrows 840 or have its pitch adjusted as depicted by arrows 842, or have its left and right pivotal movement (which will be defined as yaw for purposes of this application) to be adjusted as depicted by arrows 844.

It will be appreciated that in another embodiment the attitude control structures or individual attitude control systems may be mounted directly on the satellite without the use of outriggers.

As discussed above, mercury may be used as the liquid to be ejected from the holes. While other liquids may be used, it should be borne in mind that mercury has a much higher density than water and has a surface tension of 450 dyne per centimeter compared to 72 dyne per centimeter for water. As mentioned above, the density of mercury is 13.5 kg per liter=13.5×10³ kg per cubic meter. For a satellite having a mass of 5 kg and a radius R of 0.1 m and a length L of 0.2 m, and using a droplets radius of 37 μm ejected at a droplets velocity of 10 m/s, the moment of inertia, droplet volume, droplet mass, droplet momentum and angular velocity can readily be calculated.

Thus assuming the use of mercury and a satellite defined by a solid cylinder of radius R=0.1 m and length L=0.2 m, mercury droplets fired from the surface at 90° will have a momentum of P and generate a rotational velocity ω as given by the equation P*R=I*ω where I is the moment of inertia of the cylindrical satellite.

I for end over end rotation is given by I=0.25MR²+1/12 ML² and for rotation about its longitudinal axis I=0.5 MR².

Thus I for end over end rotation is 0.029 kg m²

I for rotation about the longitudinal axis is 0.025 kg m²

Assuming a mercury droplet size of 212 pl fired at 10 m/s, its mass m_{drop} (given by multiplying the volume by its density), is 2.864×10⁻⁹ kg

Therefore the droplet momentum P_{drop}=m_{drop}*v=2.864×10⁻⁸ kg m/s
Thus the angular velocity of the satellite (end over end) as a result of firing one droplet is ω_{drop}=P_{drop}(L/2)/I=9.821×10⁻⁸ rads/sec

For a rotation of 1 degree (end over end) in 10 minutes the required ω_{req} is 2π/(360×10×60) rads/second.

The number of drops required is therefore ω_{req}/ω_{drop}=296 drops

In a control system comprising a matrix of die or substrate structures with a total of 5×10⁶ holes this allows 5×10⁶/296 groups of firings. Every adjustment requires an opposite firing to stop the satellite, the total number of adjustments is 5×10⁶/(296×2)=8.44×10³.

Over a lifespan of 30 years=10950 days this gives an average of 0.77 end over end adjustments per day.

For rotation about the longitudinal axis, the angular velocity as a result of firing one droplet is ω_{drop}=P_{drop}(R)/I=1.146×10⁻⁷ rads/sec

Therefore a rotation of one degree about the longitudinal axis requires 254 drops thus provide a total of 9.847×10³ adjustments or an average of 0.9 adjustments per day over a 30 year period.

If more adjustments have to be made on average, either multiple control devices could be affixed to the satellite or additional mercury could be provided, e.g., from a reservoir, as discussed above.

In the above embodiment the satellite was depicted as a cylindrical structure 20 cm in length and 10 cm in diameter and weighing 5 kg.

New generation satellites, including pico satellites (in the range of 100 g-1 kg), nano satellites (in the range of 1-10 kg), and micro satellites, often have a cubic configuration. It will therefore be appreciated that the example above of a cylindrical satellite was for illustrative purposes only.

In one embodiment, in order to create greater flexibility, multiples of holes e.g., 296 or 254 holes each firing once (depending on the location of the device—whether for rotation end over end or about the longitudinal axis) or fewer holes firing multiple times in succession, are grouped together to be fired as groups.

In another embodiment small wafer elements e.g. individual die or small groups of die may share a common reservoir and each hole may have its own heating element or multiple holes may share a heating element, i.e., the holes in a die may share a heating element or each have their own heating element, the die defining a partially autonomous module. Such modules with their own reservoir thus include a reservoir dedicated to replenishing only the holes of that module. This allows ejection devices to be built up to the desired size by simply securing the desired number of modules to a frame. For practical reasons the modules that are combined are preferably centrally controlled from one processor.

As mentioned above, the attitude control systems can be standardized.

Similarly, the modules discussed above can be standardized and used for more than one size of satellite by controlling the number of firings.

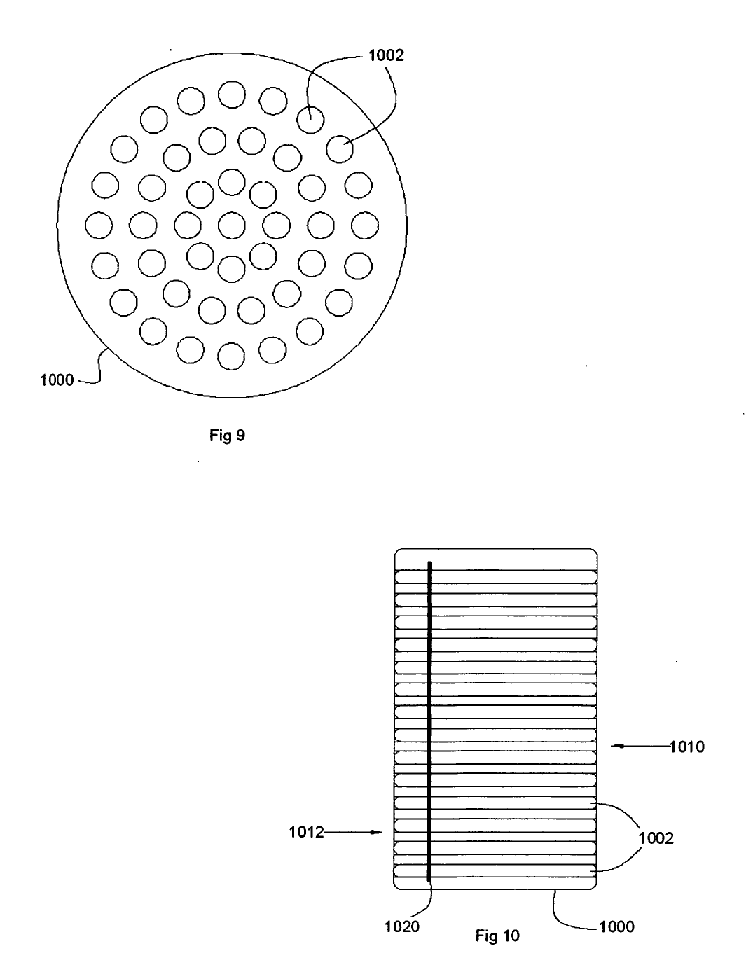

It will be appreciated that in the embodiments making use of a substrate structure in which the heating elements are provided on the distal surface of the substrate structure that is in contact with an underlying reservoir of mercury or other liquid, heating of the liquid in the substrate structure holes will produce conductive heat loss into the underlying liquid reservoir. In order to minimize this large liquid area in contact with the heating elements, another embodiment of a substrate structure is shown in FIGS. 9 and 10. This embodiment provides a substrate structure 1000 with 74 μm diameter holes 1002 extending from a distal surface 1010 to a proximal surface 1012. In this embodiment the substrate structure is 300-500 μm thick thereby providing a long, thin channel of liquid and avoiding the need to place the heating elements in proximity to the liquid reservoir. The heating elements 1020 in this embodiment are formed at a depth from the proximal surface 1012 of about 74 μm thus being about the same as the hole diameter in this embodiment. Thus, in this embodiment the column of liquid below the heating elements 1020 provides the propulsion base that the droplets of ejected liquid push off of as they are propelled from the holes 1002 by the sudden expansion of the vaporized liquid due to the heating by the heating elements. The columns of liquid beneath the heating elements in such embodiments provide a much smaller surface area for conductive heat transfer.

As mentioned above, one variation of the embodiment (such as the one depicted in FIG. 10) allows a separate reservoir of liquid to be eliminated altogether, the supply of mercury or other liquid being housed solely in the long holes of the substrate structure, which allows multiple firings per channel, each firing resulting in the ejection of only a portion of the liquid that is located on the proximal side of the heating element. In such an embodiment capillary attraction cannot be relied on to move the column of fluid up the hole since there is no body of liquid from which to draw from. Thus, in order to ensure that the mercury continues to move up the hole, in this embodiment, a differential pressure is maintained across the column of liquid to ensure that the column continues to be sucked toward the proximal surface as droplets are ejected, at a speed corresponding to the ejection rate. As mentioned above, a bag or piston may be used to exert a pressure on the distal end of the holes to control the rate of movement of liquid toward the proximal surface.

In the above example in which holes or ejection channels of 37 um diameter and 37 um depth were use, the energy to be generated by the resistive element to eject a mercury droplet can be calculated by combining the energy required to heat the droplet from ambient of say 20 degrees C. to the boiling point of mercury at 356.73 degrees C., with the energy required to turn the mercury to vapor. The specific heat of mercury (C) is 0.14 J/g degree C.

The temperature to heat from a droplet to mercury from 20 to 356.73 degrees C. (delta T of 336.73 degrees C.) can be calculated from the mass of the droplet.

$$\begin{matrix}The droplet mass = drop volume \times density \\ = 37 \times {10}^{- 6} {π ( 18.5 \times {10}^{- 6} )}^{2} \times 13500 \\ = 3.978 \times {10}^{- 14} \times 13500 \\ = 5.37 \times {10}^{- 10} kg\end{matrix}$$

Thus Energy Q=droplet mass×specific heat×delta T=2.5319×10⁻⁵ J

$$Energy to vaporize mercury droplet from boiling point ( Vapor ) = ( latent heat ) K \times drop mass = 295 \times {10}^{3} J \text{/} kg \times 5.37 \times {10}^{- 10} kg = 1.584 \times {10}^{- 4} J$$

Total energy to vaporize mercury droplet from 20 degrees C.=Q+Vapor, which is approximately 1.837×10⁻⁴ J

However, the above calculations are based on vaporization of the entire droplet. In practice only a thin layer of the order of 1 μm is vaporized.

So instead of a depth of liquid of 37 um, only a layer thickness of 0.1 um has to be heated, which requires only 1/370 of the energy=4.96×10⁻⁷ J

A 1 μm layer of the mercury has a volume of 1.08×10⁻¹⁶ m³ and a mass of 1.45×10⁻¹² kg. Since the mercury has an atomic mass of 200.59 g/mol, the layer of mercury that is vaporized contains 7.2287×10⁻¹² mol. When in the vapor phase, the adiabatic volume of mercury is 22.4 liters/mol. Therefore each hole produces 1.62×10⁻¹⁰ liters of mercury vapor to generate the ejection pressure for the droplet of mercury that is ejected.

Empirical data relating the adiabatic volume of mercury vapor to the emission velocity for different diameter holes is given in Table A below. This allows the a preferred droplet velocity to be related to a hole diameter to optimize hole size.

For purposes of this application, the thermal creation of a bubble of vapor within a channel to eject a volume of liquid from the channel will be defined as thermal ejection.

TABLE A

| Pressure | diameter | velocity |
|---|---|---|
| Pa | m | m/s |
| 4.85E+05 | 1.00E−04 | 6.84E+00 |
| 4.85E+05 | 7.50E−05 | 6.84E+00 |
| 4.85E+05 | 5.00E−05 | 6.84E+00 |
| 4.85E+05 | 5.00E−06 | 3.67E+00 |
| 3.45E+05 | 1.00E−04 | 5.7697354 |
| 3.45E+05 | 7.50E−05 | 5.7697354 |
| 3.45E+05 | 5.00E−05 | 5.77E+00 |
| 3.45E+05 | 5.00E−06 | 2.75E+00 |
| 2.07E+05 | 1.00E−04 | 4.47E+00 |
| 2.07E+05 | 7.50E−05 | 4.47E+00 |
| 2.07E+05 | 5.00E−05 | 4.47E+00 |
| 2.07E+05 | 5.00E−06 | 1.76E+00 |

The other concern mentioned above when dealing with attitude control devices in outer space is the issue of temperature. Extreme temperature variations exist in space due to the lack of atmosphere, and may range from −243 degrees C. when shielded from the sun's radiation to over 100 degrees C. when exposed to the sun. Mercury, for example, has a boiling point of 356.9 degrees C. and a freezing point of −38.8 degrees C. Thus the devices, which are typically mounted at various locations on the satellite, may be exposed to temperatures that exceed the boiling point of mercury or drop below the freezing point of mercury. The devices therefore have to be temperature controlled.

One embodiment of the invention makes use of a thermo-electric device (thermogenerator) operating on the Seebeck effect, wherein the temperature gradient from a hot surface to a cold surface across a pair of junctions induces a corresponding logarithmic mobile charge carrier gradient. The most usual of these are electrons—for example, across metal. This temperature gradient induced current from the thermogenerator can be stored in a battery. In addition to absorbing heat at the hot junction and giving off heat at the cold junction during the battery charging process, current from the battery can be used at another time to heat (or Peltier cool) either junction to maintain the correct temperature of the mercury. Similarly current from the battery can be used to warm the mercury by heating a resistive element within the substrate, or even to power the heating elements that are used for thermal ejection. Thus the charged battery from the Seebeck effect can, in one embodiment be used at a later time for vaporizing the mercury. DC to DC conversion electronics may be used to increase the voltage level from the battery in order to provide the desired voltage across the heating elements to create an appropriate amount of heat. Such temperature control allows the temperature of the liquid that is to be ejected to be controlled prior to ejection, to avoid the liquid from boiling or freezing and preferably keeping it within a defined range that optimizes the liquid's viscosity. The temperature control device, such as a thermo-electric device is, in one embodiment, connected to the control structure, e.g., attached to the liquid reservoir to control the temperature that is fed to the ejection channels of the control device.

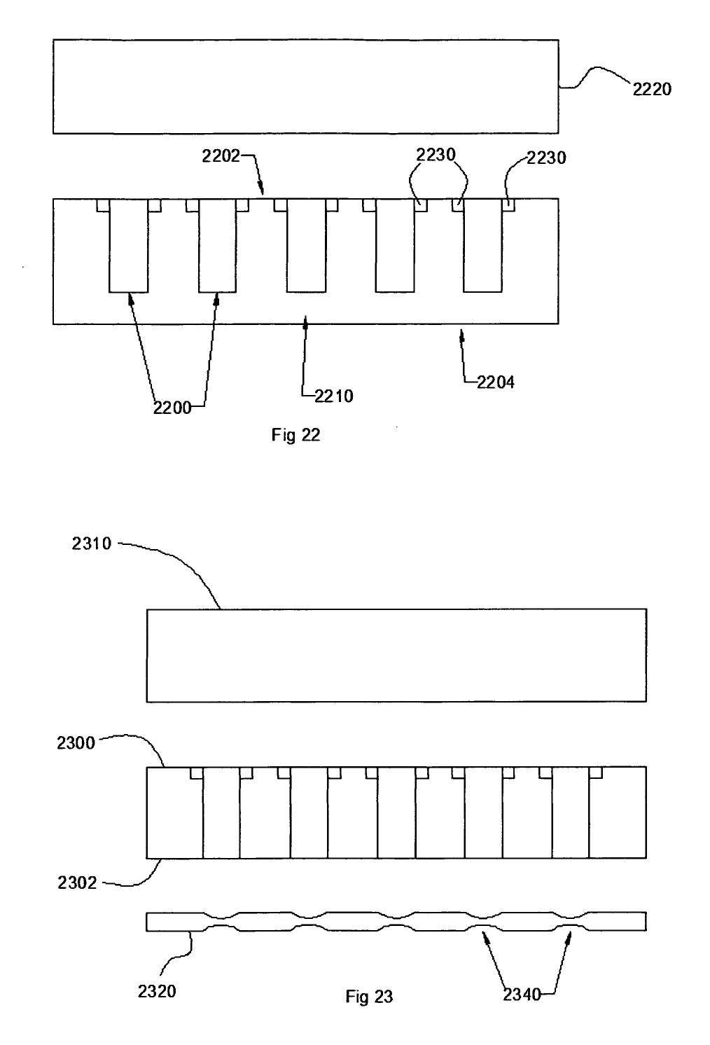

In the above embodiments, various configurations were discussed in which a reservoir was secured to the distal surface of the substrate structure or the channel was sufficiently long to facilitate multiple firings from a single channel. However, in one embodiment, the substrate structure is configured without a reservoir, allowing a single firing of liquid from each hole, either simultaneously or individually. One such embodiment is shown in FIG. 22, which comprises holes 2200 formed into a substrate structure from one surface 2202 (referred to herein as the proximal surface) and stopping short of the distal surface 2204 to define an integrally formed covering 2210 at one end of the holes, as shown in FIG. 21. Heating elements 2230 are provided in the substrate structure at a defined distance from either the distal or proximal end to facilitate the thermal firing or ejection. In this embodiment, after filling the holes with the liquid, the holes are sealed with a separate disk 2220 that covers the proximal surface and can be made of the same material as the substrate structure. Either the disk 2220 or integral cover 2210 can be chosen to be much thinner than the opposite structure (2210, 2220, respectively) to allow the thermally ejected liquid particles to break through the thinner structure during thermal ejection. In another embodiment, instead of a disk to cover the holes, the holes may be closed by a micro-valve, e.g., a non-mechanical micro-valve such as the paraffin plugs, or ferro-liquid micro-valves or electro-rheological fluid micro-valves discussed above.

In another embodiment, as shown in FIG. 23, holes are formed to extend all the way through the substrate structure from the proximal surface 2300 to the distal surface 2302. S subsequently covers 2310, 2320 are secured to each surface of the substrate structure, one cover being thinner or weaker than the other to define the ejection side that is broken when the droplets are ejected. Preferably the breakable cover is configured to break only over the holes that are fired, e.g. by providing thinner portions 2340 over the holes as shown in FIG. 22. Again, instead of a breakable cover the one end of the holes can be sealed using a micro-valve.

The present invention provides a satellite attitude control system that permits much finer control over the attitude adjustments compared to monopropellant thrusters. For instance in the example given above for one monopropellant micro-chemical thrusters for micro satellites based on a hydrogen peroxide fuel the finest resolution was limited to bursts of 80 μNs pulses. As discussed above, in a 20 cm×10 cm nano satellite with a mass of 5 kg this would create an end-over-end rotation speed in excess of 4 degrees/second making it impossible to finely adjust the attitude. In contrast, the embodiment of the invention discussed above that made use of 37 μm diameter holes to eject mercury at 10 m/s, a 2857 times finer adjustment granularity can be achieved. This allows for a 1 degree adjustment over a 10 minute period by firing 296 holes from its MEMS substrate. As discussed above, the present invention also has the flexibility of increasing or decreasing hole size in a substrate structure or providing a substrate structure with a range of hole sizes, and can control the number of firings to accommodate different granularity requirements.

The invention is also much lighter than other prior art attitude adjusters such as Momentum/Reaction Wheels or Control Moment Gyroscopes.

While much of the discussion above relates to attitude control of a satellite, it will be appreciated that the control system is not limited to attitude control of satellites but allows for any position change, including translational movement of the satellites. It will be appreciated that the nature of the movement achieved depends on the positioning of the control systems on the satellite and the selection of the control systems to activate, including, which holes to fire.

While the present application has been described with reference to specific embodiments it will be appreciated that the invention could be implemented in different ways without departing from the scope of the invention as defined by the claims.

What is claimed is:

1. A satellite control system operable in a low pressure environment, comprising
at least one substrate structure having a distal surface and a proximal surface with multiple holes extending at least partially into the substrate structure from the proximal surface,
at least one heating element arranged at the bottom of the holes or at a predefined distance from the proximal surface,
a liquid that is thermally ejectable from the holes by the at least one heating element, and
at least one cover, shutter, or valve for selectively sealing the liquid from the low pressure environment.

2. A control system of claim 1, wherein the liquid is a non-volatile liquid.

3. A satellite control system of claim 1, further comprising an electrical circuit that includes at least one controllable switch for controlling current flow to the at least one heating element.

4. A satellite control system of claim 1, wherein the holes extend through the substrate structure from the proximal surface to the distal surface.

5. A satellite control system of claim 1, further comprising a liquid supporting reservoir in flow communication with the holes in the substrate structure.

6. A satellite control system of claim 1, wherein the liquid is a high-density liquid with a density greater than that of water.

7. A satellite control system of claim 6, wherein the liquid contains particulate matter.

8. A satellite control system of claim 7, wherein the particulate matter includes ferrous particles.

9. A satellite control system of claim 6, wherein the liquid is mercury.

10. A satellite control system of claim 1, wherein the at least one valve comprises at least one micro-valve.

11. A satellite control system of claim 10, wherein the at least on micro-valve includes a non-mechanical ferro-fluid valve and the liquid includes ferrous particles.

12. A satellite control system of claim 10, wherein at least one of the micro-valves comprises a piezoelectrically actuated micro-valve.

13. A satellite control system of claim 5, further comprising a pressure exerting means for exerting pressure on the liquid in the reservoir.

14. A satellite control system of claim 13, wherein the pressure exerting means comprises an expandable balloon arrangement or plunger arrangement making use of a gas under pressure.

15. A satellite control system of claim 13, wherein the pressure is controlled so as to limit the liquid flow rate into each hole due to the pressure differential and capillary action, to a pre-defined ejection volume per ejection interval.

16. A satellite control system of claim 1, wherein the substrate structure includes silicon carbide or any of its poly types (different atomic arrangements).

17. A satellite control system of claim 16, wherein the silicon carbide has a 6 H hexagonal crystal lattice arrangements.

18. A satellite control system of claim 1, wherein the holes formed in the substrate structure have one or more pre-defined diameters.

19. A satellite control system of claim 18, wherein streets between the holes are wider than the hole diameters.

20. A satellite control system of claim 1, wherein the substrate structure is implemented as a MEMS device (micro electromechanical system).

21. A satellite control system of claim 1, wherein each hole is provided with a separate heating element located at a predefined distance from the proximal end of each hole, said heating elements defining part of an electrical circuit that includes at least one switch for each heating element or for a set of heating elements.

22. A satellite control system of claim 21, further comprising a processor or controller for determining at least one of, which holes, the number of holes, and the number of firings for such holes that is required for a particular attitude adjustment of the satellite.

23. A satellite control system of claim 22, further comprising a radio receiver for providing signals to the processor defining an attitude adjustment or desired orientation.

24. A method of controlling the position of a satellite, comprising ejecting a liquid from a channel by thermal ejection.

25. A method of claim 24, wherein the position control comprises an attitude adjustment of the satellite.

26. The method of claim 25, further comprising ejecting from multiple channels.

27. A method of claim 26, wherein the channels comprise holes formed in a substrate structure.

28. A method of claim 27, wherein the substrate comprises a SiC substrate.

29. A method of claim 28, wherein the liquid comprises a high density liquid.

30. A method of claim 29, wherein the liquid comprises mercury.

31. A method of claim 30, wherein the ejection of the liquid is controlled by a processor.

32. A method of claim 31, wherein the holes are be pre-filled with the non-volatile liquid or filled shortly before ejection.

33. A method of claim 32, wherein the holes are filled from a reservoir less than 1 minute prior to ejection.

34. A method of claim 33, wherein the holes are refilled one or more times from the reservoir after liquid has been ejected from the holes.

35. A method of claim 34, wherein the processor controls which holes to eject from, and the number of holes from which to eject.

36. A method of claim 35, wherein the holes are formed by MEMS technology in a SiC substrate.

37. A method of claim 24, further comprising controlling the temperature of the liquid prior to ejection.

38. A method of claim 24, further comprising controlling the differential pressure across the channel.

39. A method for controlling the attitude of a satellite, comprising
providing multiple holes of varying size in a substrate structure to define an attitude control element,
securing at least one attitude control element to the satellite,
providing a liquid in the holes, and
thermally ejecting the liquid from one or more of the holes.

40. A satellite control system, comprising
a substrate structure with multiple holes extending into the substrate structure, the holes being provided with heating elements, and
mercury provided in the holes or in a separate reservoir for subsequent filling of the holes.

41. A satellite control system of claim 40, wherein the substrate structure is made from SiC.

42. A satellite control system, comprising
a SiC substrate structure with multiple holes extending into the substrate structure,
a liquid provided in the holes or in a separate reservoir for subsequent filling of the holes, and
at least one heating element for thermally ejecting the liquid from the holes.

43. A satellite control system of claim 42, wherein the liquid is mercury.

44. A satellite control system of claim 42, further comprising a controller for controlling at least one of, the number of holes that eject liquid, and the number of times that each hole ejects liquid for a required attitude adjustment.

45. A satellite control system of claim 44, wherein the controller is configured to account for the mass of the satellite and the distance of the substrate structure from the rotational axis about which the attitude is to be adjusted.

46. A satellite control system for controlling a satellite in a low pressure environment, comprising
a substrate structure with multiple holes extending into the substrate structure,
a liquid provided in the holes or in a separate reservoir for subsequent filling of the holes,
at least one shutter, cover, or micro-valve for controlling access of the liquid to the low pressure environment, and
at least one heating element for thermally ejecting the liquid from the holes, wherein the substrate structure and the at least one shutter, cover, or micro-valve are made of a material that includes at least one of Si, SiC, SiN, AlN, GaN, AlGaN, and GaAs.

47. A satellite control system of claim 46, wherein the substrate structure and the at least one shutter, cover, or micro-valve are made of different materials that include at least one of Si, SiC, SiN, AlN, GaN, AlGaN, and GaAs.

48. A satellite control system of claim 46, wherein the substrate structure includes SiC or SiN epitaxially grown on Si or SiC.
